SEQUENCE LISTING (1 sequence)

SEQ ID NO: 1 - protein, 33 aa, Homo sapiens
KWKVFKKIEKKWKVFKKIEKAGPKWKVFKKIEK

(19) United States
(12) Patent Application Publication
(10) Pub. No.: US 2016/0310928 A1
(43) Pub. Date: Oct. 27, 2016

(54) METHOD FOR PERFORMANCE OPTIMIZATION OF PROTEIN CHIP PRODUCED UNDER EXTERNAL ELECTRIC FIELD APPLIED IN DIFFERENT DIRECTION AND DEVICE FOR PROVIDING EXTERNAL ELECTRIC FIELD IN DIFFERENT DIRECTION

(71) Applicant: NATIONAL APPLIED RESEARCH LABORATORIES, TAIPEI CITY (TW)

(72) Inventors: HUEIH-MIN CHEN, HSINCHU (TW); WEI-JEN WU, HSINCHU 300 (TW); HSUAN-YU HUANG, HSINCHU 300 (TW)

(21) Appl. No.: 14/753,131

(22) Filed: Jun. 29, 2015

(30) Foreign Application Priority Data
Apr. 22, 2015 (TW) 104112833

(51) Int. Cl. B01J 19/08

(52) U.S. Cl. CPC B01J 19/087; B01J 2219/0803; B01J 2219/089

(57) ABSTRACT

A method for performance optimization of protein chips produced under an external electric field applied in different directions and a device that provides the external electric field in different directions are revealed. Firstly a plurality of protein chips is produced under an external electric field applied in different directions. Then a binding force between protein molecule on the protein chip and a ligand is measured and compared. Thus an angle of the external electric field applied that achieves performance optimization while using the protein molecule to produce the protein chips is found out. The device providing the external electric field in different directions includes a rotatable electric field support rotating around a carrier used for loading the protein chips. The electric field support is disposed with electrodes for providing the protein chips on the carrier the external electric field in different directions.

### BACKGROUND OF THE INVENTION

1. Fields of the Invention

The present invention relates to a method for performance optimization of protein chips produced under an external electric field applied in different directions and a device providing the external electric field in different directions, especially to a method and a device that apply an external electric field in different directions to chips during manufacturing processes of protein chips. Thus protein molecules are fixed on the respective chip in different orientations. Then a binding force between the protein molecule on surface of the respective chip and a corresponding ligand is measured and compared so as to learn the direction of the external electric field applied that achieve better or optimal performance of the protein chips while producing the protein chips.

2. Descriptions of Related Art

The performance of the protein chip is determined by stability, homogeneity, and orientation of protein molecules on the chip. The self-assembled monolayer (SAM) technique uses covalent bonding to fix single-layer of protein molecules on surface of the chip. The stability and homogeneity problems have been solved. For further improvement of performance of the protein chip, the problem of orientation of protein molecules should be solved.

Proteins are bio-molecules with three-dimensional structure. The function of a protein is strictly related to its spatial conformation. The binding between protein molecules is achieved by recognizing specific structural mortif in binding sites. The binding of protein molecules is directional. While manufacturing protein chip, the binding efficiency of the protein molecules with its ligand is reduced if the binding site of the protein molecule is buried, without being exposed on the surface of the chip.

During the processes for fixing the protein molecules on the chip, the protein molecules are randomly oriented without specific external force applied. Thus the binding efficiency between the protein molecules on the chip and a ligand for detection target is reduced. This results in poor detection performance.

### SUMMARY OF THE INVENTION

Therefore it is a primary object of the present invention to provide a method for performance optimization of protein chips produced under an external electric field applied. During production of protein chips, the external electric field in different directions is applied to the protein molecules. The protein molecules are deflected by the external electric field due to polarity thereof. Then an atomic force microscope (AFM) is used to measure a binding force between the protein molecule of the respective protein chip and ligand molecule. Thus the angle of the external electric field applied that achieves performance optimization of the protein chips can be found out by comparison of the binding force. The protein molecules on the protein chip are deflected by the external electric field applied so that binding sites of the protein molecules are exposed on surface of the chip and optimal performance of the protein chip is achieved while using the protein molecules to produce the protein chips.

It is another object of the present invention to provide a device that provides an external electric field during production of protein chips. The device includes a carrier for loading chips and an electric field support able to be rotated around the carrier. By electrode arranged at the electric field support, the external electric field in different directions is applied to the protein chips on the carrier. Thus the protein chips are produced under the external electric field in different directions and the direction of the external electric field that achieves better or optimal performance of the protein chips is found out.

It is a further object of the present invention to provide protein chips with better or optimal performance that are produced under an external electric field applied that achieves better or optimal performance of the protein chips. The protein molecules on the protein chip are deflected by the external electric field and fixed on the chip with an angle which most binding sites exposed. Thus optimization of the binding between the protein molecules on the protein chip and the ligand molecules is achieved.

In order to achieve the above objects, a method for performance optimization of protein chips produced under an external electric field applied in different direction according to the present invention includes the following steps. Firstly take and drop a protein solution containing at least one protein molecule to a first chip. Then apply an external electric field to the first chip for deflecting and fixing the protein molecule on the first chip while an angle between the external electric field and a line perpendicular to the first chip is a first angle. Next take and drop the protein solution to a second chip. Then apply an external electric field to the second chip for deflecting and fixing the protein molecule on the second chip while an angle between the external electric field and a line perpendicular to the second chip is a second angle. Later measure a first binding force between the protein molecule on the first chip and a ligand molecule for the protein, and a second binding force between and the protein molecule on the second chip and the ligand respectively. At last, compare the first binding force with the second binding force to find out which angle is the angle of the electric field that achieves performance optimization while using the protein molecule to produce the protein chips.

Another method that achieves performance optimization of protein chips produced under an external electric field applied of the present invention is revealed and having the following steps. Firstly take and drop a protein solution containing at least one protein molecule to a plurality of chips respectively. Then take a plurality of the chips and apply an external electric field in different directions to the respective chip. An angle of the external electric field applied is defined as an angle between the external electric field applied to the chip and a line perpendicular to the chip. The angle is ranging from 0 to 360 degrees Next measure a binding force between the protein molecule on the respective chip and at least one ligand molecule for the protein. At last compare the binding force with one another to find out the angle of the external electric field applied that achieves performance optimization of the protein chips while using the protein molecule to produce the protein chips.

Moreover, a device that provides an external electric field for production of protein chips according to the present invention includes a carrier and an electric field support. The carrier is arranged horizontally while at least one side of the electric field support is pivotally connected to the carrier. The electric field support is composed of a first electrode disposed on one side of the carrier and a second electrode arranged at the other side of the carrier. An external electric field passed through the carrier is formed when a voltage is applied between the first electrode and the second electrode. When the electric field support is rotated in relation to the carrier, the external electric field formed by the first electrode and the second electrode is also driven to rotate in relation to the carrier.

Furthermore, the present invention reveals a protein chip with optimal performance including a chip and a protein layer. The protein layer contains at least one protein molecule that is deflected under an external electric field applied and then is fixed on the chip. The external electric field is applied to the chip at a certain angle that achieves performance optimization of the protein chip. The performance of the protein chip is highly associated with a binding force between the protein molecule and a ligand molecule for the protein.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a schematic drawing showing component connection of an embodiment according to the present invention;

FIG. 1B is a flow chart showing steps of an embodiment according to the present invention;

FIG. 2 is a flow chart showing steps of another embodiment according to the present invention;

FIG. 3A is a line chart showing results of a binding force between immunoglobulin G and protein A detected by an embodiment according to the present invention;

FIG. 3B is a radar chart showing results of a binding force between immunoglobulin G and protein A detected by an embodiment according to the present invention;

FIG. 3C is another line chart showing results of a binding force between immunoglobulin G and protein A detected by an embodiment according to the present invention;

FIG. 4A is a line chart showing results of a binding force between anti-CB1a antibody and CB1a detected by an embodiment according to the present invention;

FIG. 4B is a radar chart showing results of a binding force between anti-CB1a antibody and CB1a detected by an embodiment according to the present invention;

FIG. 5 is a schematic drawing showing structure of another embodiment according to the present invention.

### DETAILED DESCRIPTION OF THE PREFERRED EMBODIMENT

In order to learn features and functions of the present invention, please refer to the following embodiments and detailed description.

A method and a device of the present invention features on that an external electric field is applied in different directions while producing protein chips. Thus protein molecules on the respective protein chip are fixed on the chip with different angles therebetween. Then measure and compare a binding force between the protein molecule on the respective protein chip and a ligand molecule for the protein molecule so as to find out the direction of the external electric field that achieves performance optimization of the protein chips while using the protein molecule to produce the protein chips. Moreover, the device includes an electric field support that is rotatable around a carrier used for loading protein chips. The electric field support is arranged with electrodes for providing the protein chips on the carrier the external electric field in different directions. Next an atomic force microscope (AFM) is used to check the respective protein chip produced under the external electric field applied in different directions and find out the direction of the external electric field that achieves performance optimization of the protein chips.

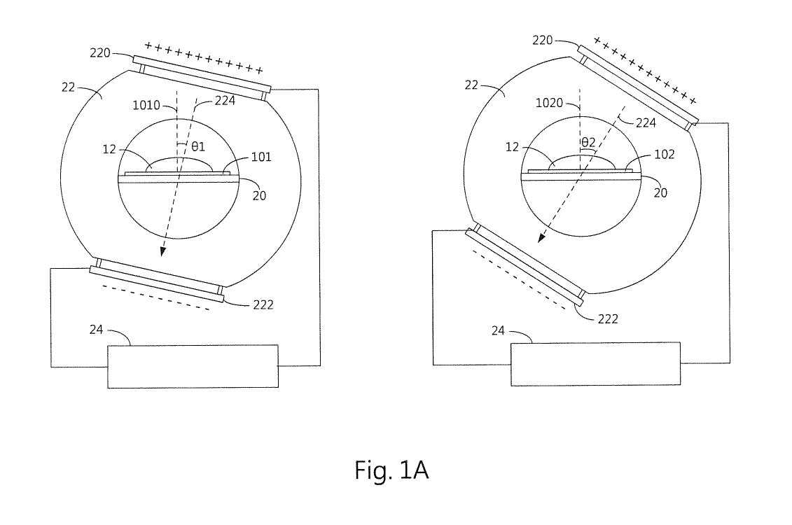

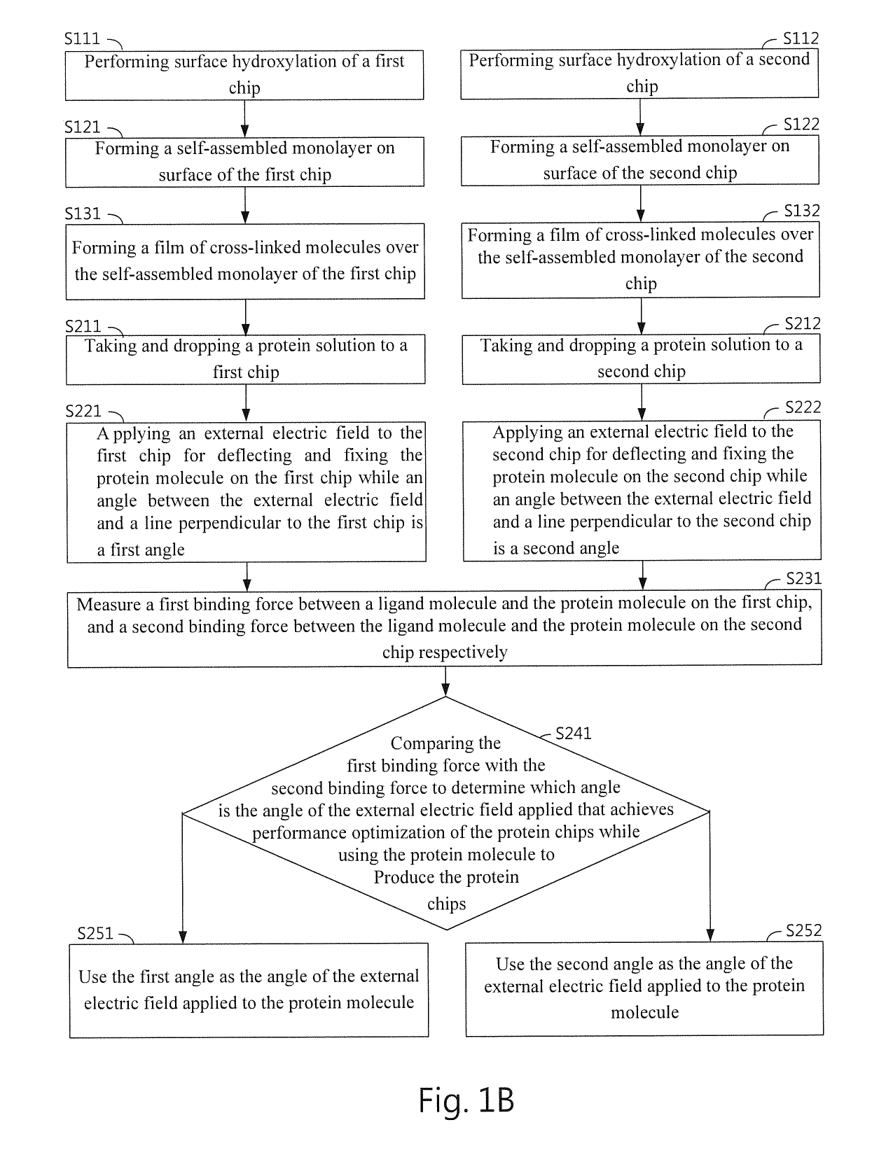

Refer to FIG. 1A and FIG. 1B, a first chip 101 is set on a carrier 20 and a second chip 102 is put on another carrier 20. Take and drop a protein solution 12 containing at least one protein molecule to the first chip 101 and the second chip 102 respectively for production of protein chips. During the procedures, a power source 24 applies a voltage to a first electrode 220 and a second electrode 222 disposed on an electric field support 22 to form an external electric field 224. The electric filed support 22 is rotatable around the carrier 20. An angle between the external electric field 224 applied to the first chip 101 and a line 1010 perpendicular to the first chip 101 is a first angle θ1 while an angle between the external electric field 224 applied to the second chip 102 and a line 1020 perpendicular to the second chip 102 is a second angle θ2.

As shown in FIG. 1B, a method for performance optimization of protein chips produced under an external electric field applied according to the present invention can select one of at least two angles of the electric field applied that achieves better performance and mainly having the following steps.
Step S211: take and drop a protein solution to a first chip;
Step S221: apply an external electric field to the first chip so that a protein molecule is deflected and fixed on the first chip; an angle between the external electric field and a line perpendicular to the first chip is a first angle;
Step S212: take and drop the protein solution to a second chip;
Step S222: apply an external electric field to the second chip so that a protein molecule is deflected and fixed on the second chip; an angle between the external electric field and a line perpendicular to the second chip is a second angle;
Step S231: measure a first binding force between a ligand molecule and the protein molecule on the first chip, and a second binding force between the ligand molecule and the protein molecule on the second chip respectively;
Step S241: compare the first binding force with the second binding force to determine which angle is the angle of the electric field applied that achieves performance optimization of the protein chips while using the protein molecule to produce the protein chips;
Step S251: use the first angle as the angle of the external electric field applied to the protein molecule;
Step S252: use the second angle as the angle of the external electric field applied to the protein molecule;

Moreover, the first chip 101 and the second chip 102 should be treated before running the step S211 and the step S212. The pretreatment of the first and the second chips 101, 102 includes the following steps:
Step S111: perform surface hydroxylation of a first chip;
Step S121: form a self-assembled monolayer on surface of the first chip;
Step S131: form a film of cross-linked molecules over the self-assembled monolayer of the first chip;
Step S112: perform surface hydroxylation of a second chip;
Step S122: form a self-assembled monolayer on surface of the second chip;
Step S132: form a film of cross-linked molecules over the self-assembled monolayer of the second chip.

In the step S111 and the step S112, oxygen plasma is used to treat the first chip 101 and the second chip 102 for surface hydroxylation of the first chip 101 and the second chip 102. In this embodiment, the oxygen plasma is created at 250 mTorr, 80W and the plasma treatment time is 3 minutes.

In prior arts, the chips are soaked in piranha solution for 10 minutes for surface hydroxylation. Then the chips are rinsed with alcohol and pure water for removing organic substances and pollutants on surface thereof to ensure high cleanliness. In this embodiment, the oxygen plasma itself could clean the surface within a short period. The cleaning procedure using alcohol and water can be omitted. The oxygen plasma is more convenient and fast.

In the step S121 and the step S122, a self-assembled monolayer (SAM) is formed on the first chip 101 and the second chip 102 respectively by using 3-Aminopropyltrimethoxysilane (3-APTMS) with amino group. In this embodiment, a 3-APTMS solution is mixed in a ratio of 3-APTMS (purity 97%) to alcohol (purity 99.9%) of 1 to 100. Then the first chip 101 hydroxylated in the step S111 and the second chip 102 hydroxylated in the step S112 are soaked in the 3-APTMS solution. Leave it for an hour. Finally the first chip 101 and the second chip 102 are set into an ultrasonic cleaner filled with alcohol to remove unreacted residual 3-APTMS and get the first chip 101 and the second chip 102 with the self-assembled monolayer formed on surface thereof respectively.

In the step S131 and the step S132, glutar-aldehyde (GTA) is used to form a film of cross-linked molecules over the self-assembled monolayer of the first chip 101 and of the second chip 102. In this embodiment, the GTA with a purity of 25% is diluted with pure water in a ratio of 1:10 to get a GTA solution. Then the first chip 101 with the self-assembled monolayer formed on surface thereof after the step S111 and Step S121 and the second chip 102 with the self-assembled monolayer formed on surface thereof after the step S112 and Step S122 are soaked in the a GTA solution and leave it for an hour. A covalent bonding is formed between the amino group of the self-assembled monolayer and the aldehyde group of the GTA. Finally the first chip 101 and the second chip 102 are set into an ultrasonic cleaner filled with alcohol to remove unreacted, residual GTA and get the first chip 101 and the second chip 102 with the self-assembled monolayer and the film of cross-linked molecules formed on surface thereof respectively.

In the step S211 and the step S212, take and drop the protein solution 12 to the first chip 101 and the second chip 102 respectively. In this embodiment, dilute the protein molecules with 1× phosphate buffered saline (PBS) so that the concentration of the protein molecules is about 10 g/ml and this is the protein solution 12. Then the protein solution 12 is dropped to the first chip 101 with the self-assembled monolayer and the film of cross-linked molecules formed on surface thereof after the step S111, step S121, and step S131 and the second chip 102 with the self-assembled monolayer and the film of cross-linked molecules formed on surface thereof after the step S112, step S122 and step S132.

In the step S221 and the step S222, apply the external electric field 224 to the first chip 101 and the second chip 102 so as to fix the protein molecules in the protein solution 12 on the first chip 101 and the second chip 102 respectively. The angle between the line 1010 perpendicular to the first chip 101 and the external electric field 224 is the first angle θ1 while the angle between the line 1020 perpendicular to the second chip 102 and the external electric field 224 is the second angle θ2. In this embodiment, the first chip 101 with pretreatment in the Steps S111, S121 and S131 and dropped with the protein solution 12 in the step S211 as well as the second chip 102 with pretreatment in the S1112, S122, and S132 and dropped with the protein solution 12 in the step S212 are left under the external electric field 224 for 30 minutes so that the N-terminal (—NH₂) of the protein molecule in the protein solution 12 reacts with another aldehyde group of the GTA molecule in the film of cross-linked molecules formed on surface of the first chip 101 and the second chip 102 respectively to have covalent bonding and form a protein layer. Finally unreacted, residual protein molecules are removed by washing with 0.05M sodium hydroxide solution so as to get the first chip 101 and the second chip 102 having the self-assembled monolayer and the film of cross-linked molecules formed on surface thereof and fixed with protein molecule respectively.

In this embodiment, an atomic force microscope (AFM) is used to measure a first binding force F1 between at least one ligand molecule and the protein molecule on surface of the first chip 101, as well as a second binding force F2 between at least one ligand molecule and the protein molecule on surface of the second chip 102. In the step S231, the ligand molecule is fixed on a probe of the AFM and then measure the first binding force F1 between the probe and the first chip 101, and the second binding force F2 between the probe and the second chip 102. The first binding force F1 is formed due to affinity between the protein molecule on the first chip 101 and the ligand molecule on the probe. The second binding force F2 is generated due to affinity between protein molecule on the second chip 102 and the ligand molecule on the probe.

In the step S241, compare the first binding force F1 with the second binding force F2 to get the preferred angle (the angle of the external electric field relative to the line perpendicular to the chip) of the external electric field applied while using the protein molecule for production of the protein chips. As the checking result shows in the step S251 or S252, the preferred angle of the external electric field applied during manufacturing of the protein chip by using the protein molecule is either the first angle θ1 or the second angle θ2.

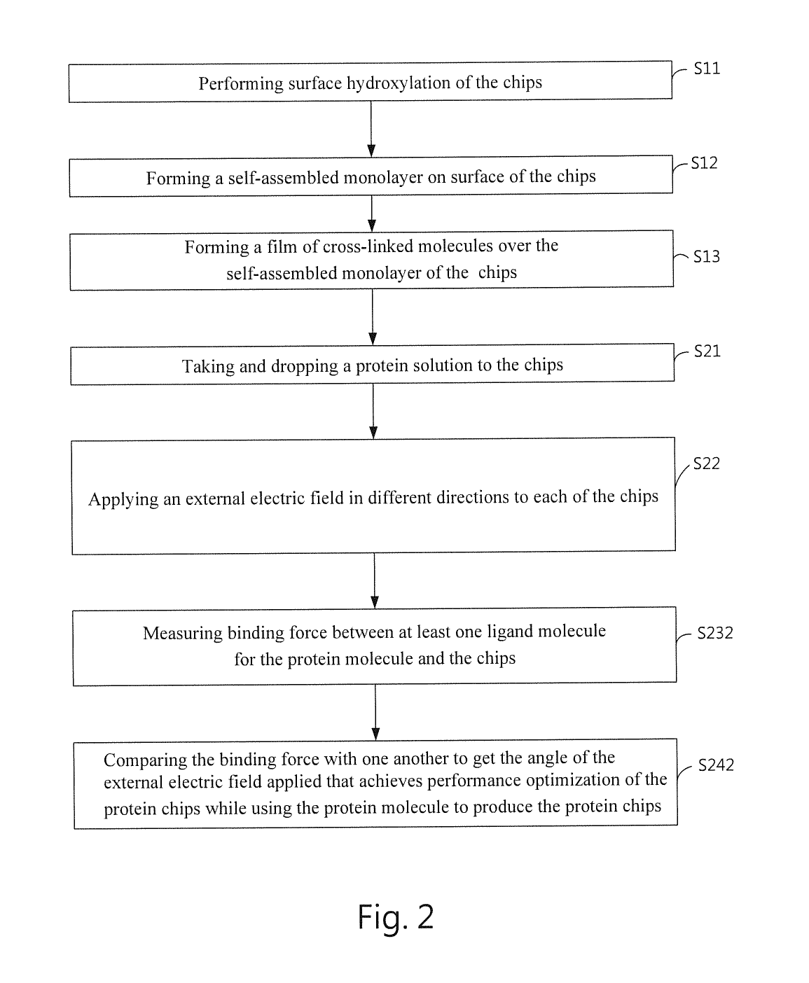

Refer to FIG. 2, a flow chart showing steps of another embodiment of the present invention is revealed. A method for performance optimization of protein chips produced under an external electric field includes the following steps.
Step S11: treat surface of a chip for surface hydroxylation of the chip;
Step S12: form a self-assembled monolayer on surface of the chip;
Step S13: form a film of cross-linked molecules over the self-assembled monolayer of the chip;
Step S21: take and drop a protein solution to the chip;
Step S22: take a plurality of the chips and apply an external electric field in different directions to the respective chip;
Step S232: measure a binding force between a ligand molecule and the protein molecule on the respective chip; and
Step S242: compare the binding force with one another to find out the angle of the external electric field applied that achieves performance optimization of the protein chips when the protein molecule is used to produce the protein chips.

The difference between this embodiment and the above embodiment is in that the external electric field 224 is applied at different angles in relation to the line perpendicular to the protein chip. The angle of the external electric field applied ranging from 0 to 360 degrees is determined according to the number of the protein chips while producing a plurality of protein chips. The angle of the external electric field is 0 degree when the electric field is penetrating the chip from top to bottom. The angle of the external electric field is 90 degrees when the electric field is penetrating the chip from right to left horizontally. For example, if there are 8 protein chips produced, the angle of the external electric field is selected as required between 1° to 360° Then AFM is used to measure the binding force between the ligand molecule on the AFM probe and the protein molecule on surface of the protein chip produced under external electric field 224. Next compare the binding force with one another to get the angle of the external electric field 224 applied that achieves performance optimization of the protein chips while producing the protein chips. The rest steps of this embodiment are similar to those of the above embodiment.

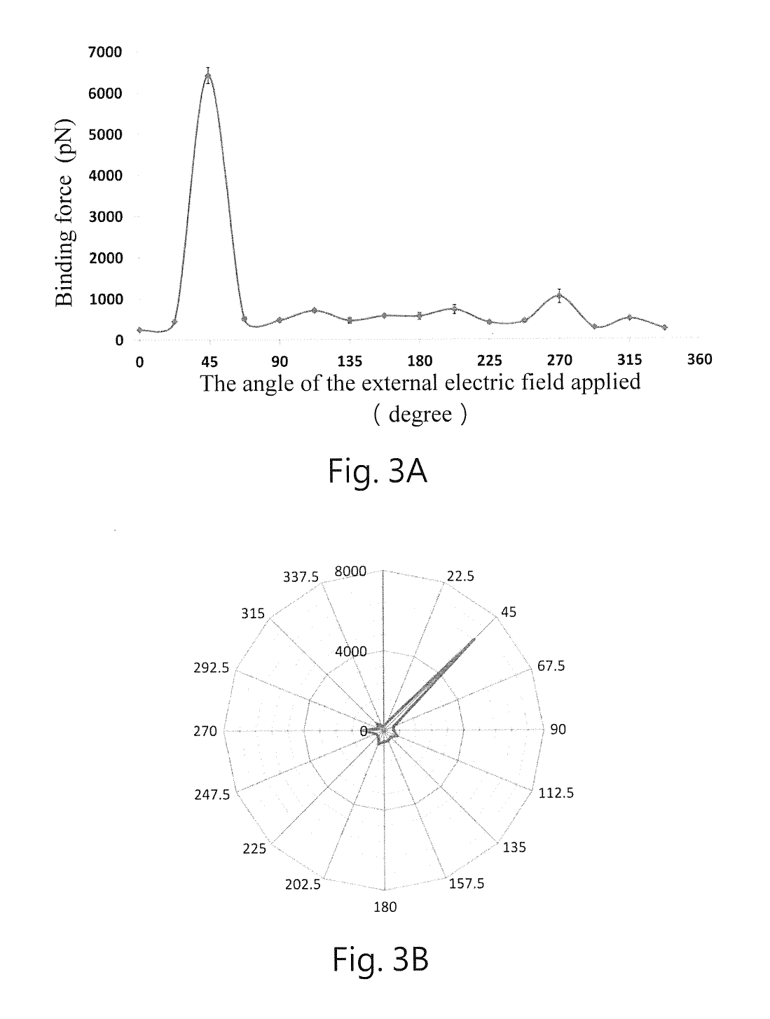

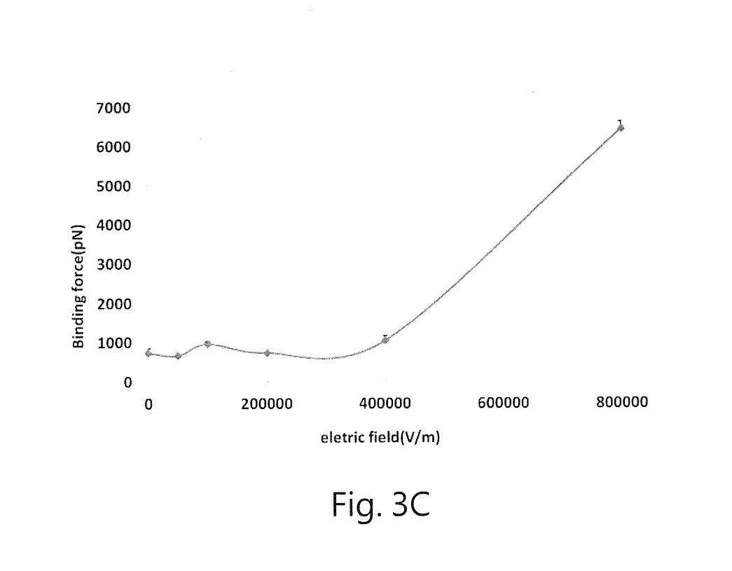

Refer to FIG. 3A, FIG. 3B, and FIG. 3C, measurement results of the binding force between immunoglobulin G (antibody IgG) and protein A detected by the method according to the present invention are revealed. In this embodiment, the immunoglobulin G is the protein molecule while the protein A is the ligand molecule. The protein A is a kind of protein isolated from the cell wall of Staphylococcus aureus and is able to bind with a fragment crystallizable (Fc) region of IgG antibody in the serum of a plurality of mammals and human beings.

The FIG. 3A and the FIG. 3B are a line chart and a radar chart respectively, showing results of the binding force between IgG antibody on the protein chip and the protein A on the probe (as the step S231 or S232 mentioned above) measured by the AFM. The protein chips are produced by fixing IgG on the chip (as the step S221 or S222 mentioned above) under the external electric field of 800,000 V/m. The angle between the external electric field applied and the line perpendicular to the chip can be 0 degree, 22.5 degrees, 45, 67.5 degrees, 90 degrees, 112.5 degrees, 135 degrees, 157.5 degrees, 180 degrees, 202.5 degrees, 225 degrees, 247.5 degrees, 270 degrees, 292.5 degrees, 315 degrees, and 337.5 degrees. The 0 angle of the external electric field means that the external electric field is vertically penetrating the protein chip from top to bottom. The unit of binding force is piconewton (pN).

As shown in FIG. 3A and FIG. 3B, the IgG antibody protein chip has optimal performance in binding/detecting protein A when the angle of the external electric field applied is 45 degrees. At the moment, the IgG antibody is deflected by the electric field applied with the angle of 45 degrees and the Fc region of IgG antibody is exposed on surface of the protein chip.

Refer to FIG. 3C, the external electric field with the angle of 45 degrees is applied in different strength including 50,000, 100,000, 200,000, 400,000, and 800,000 V/m while fixing IgG antibody on the chip during manufacturing of the protein chips. Then AFM is used to measure the binding force between IgG antibody on the protein chip and the protein A on the probe. The results show that the higher binding force is measured when the strength of the external electric field applied is 800,000 V/m. Thus the external electric field of 800,000 V/m is selected and used in FIG. 3A and FIG. 3B. Then the binding force of the protein chip produced under the external electric field of 800,000 V/m applied in different directions is measured respectively.

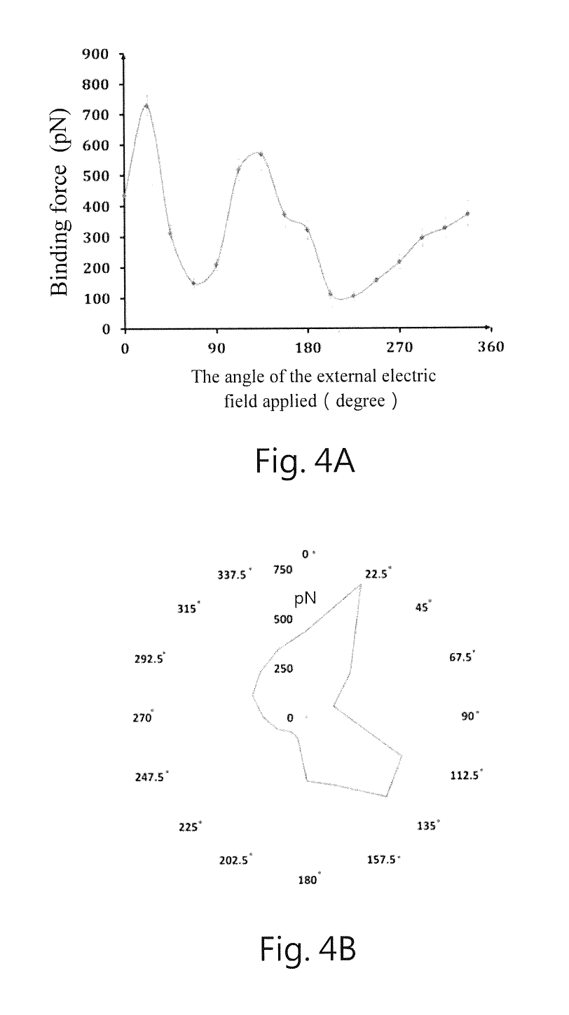

Refer to FIG. 4A and FIG. 4B, results of the binding force between anti-CB1a antibody and CB1a detected by the method of the present invention are shown. In this embodiment, CB1a that is a kind of anticancer peptide having the following amino acid sequence: Lys Trp Lys Val Phe Lys Lys Ile Glu Lys Lys Trp Lys Val Phe Lys Lys Ile Glu Lys Ala Gly Pro Lys Trp Lys Val Phe Lys Lys Ile Glu Lys is used the ligand molecule while anti-CB1a antibody is the protein molecule. Then the performance of the protein chips on binding CB1a is detected while the protein chips are produced by using anti-CB1a antibody under the external electric field applied in different directions.

The FIG. 4A and the FIG. 4B are a line chart and a radar chart respectively, showing results of the binding force (the unit is pN) between anti-CB1a antibody on the protein chip and the CB1a on the probe measured by the AFM. The protein chips are produced by fixing anti-CB1a antibody on the chip under the external electric field of 800,000 V/m while the angle between the external electric field applied and the line perpendicular to the chip can be 0 degree (the electric field is vertically penetrating the protein chip from top to bottom), 22.5 degrees, 45, 67.5 degrees, 90 degrees, 112.5 degrees, 135 degrees, 157.5 degrees, 180 degrees, 202.5 degrees, 225 degrees, 247.5 degrees, 270 degrees, 292.5 degrees, 315 degrees, and 337.5 degrees.

According to the results in FIG. 4A and FIG. 4B, the anti-CB1a antibody protein chip has better performance in binding/detecting CB1a when the angle of the external electric field applied is 22.5 degrees. At the moment, the anti-CB1a antibody is deflected by the electric field applied with the angle of 22.5 degrees and the antigen binding fragment (Fab) of the anti-CB1a antibody is exposed on surface of the protein chip, getting easier to bind CB1a.

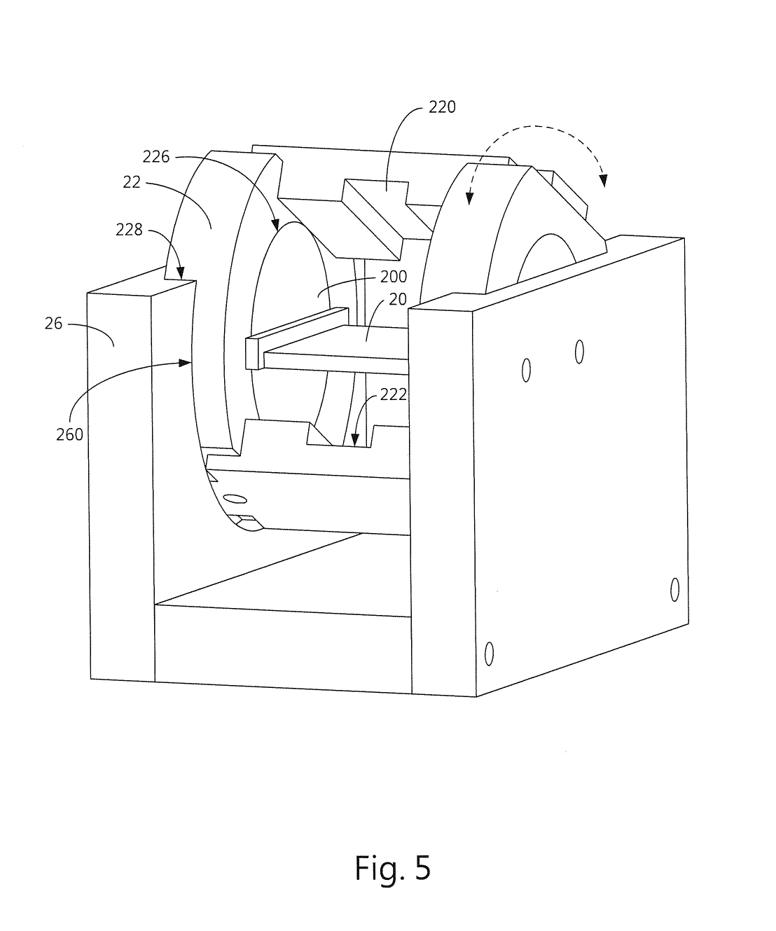

Refer to FIG. 5, a schematic drawing showing structure of further embodiment of the present invention is disclosed. A device that provides an external electric field in different directions for production of protein chips includes at least one carrier 20 and an electric field support 22. The carrier 20 is disposed horizontally and used for loading the protein chip used in the step of binding the protein molecule to the protein chip. At least one side of the electric field support 22 is pivotally connected to the carrier 20. In this embodiment, two sides of the electric field support 22 are pivotally connected to the carrier 20. The electric field support 22 consists of a first electrode 220 disposed on one side of the carrier 20 and a second electrode 222 arranged at the other side of the carrier 20, opposite to the first electrode. A voltage is applied between the first electrode 220 and the second electrode 222 to form an external electric field passed through the carrier 20. Thus the protein molecule is deflected and then connected to surface of the chip.

The electric field support 22 is pivotally connected to the carrier 20 so that the electric field support 22 can rotate around the carrier 20. The first electrode 220 and the second electrode 222 are also driven by the electric field support 22 to rotate around the carrier 20. Thus the angle of the external electric field applied can be adjusted by changing positions of the electric field support 22.

The device of the present invention further includes at least one side plate 26 disposed vertically and connected to one side of the carrier 20. In this embodiment, two side plates 26 are symmetrically connected to two sides of the carrier 20 respectively. The side plates 26 are used to support the carrier 20 to keep the carrier 20 at an elevated position, away from the ground.

Furthermore, a mounting disc 200 is set on at least one side of the carrier 20. One side of the electric field support 22 corresponding to the mounting disc 200 is arranged with a mounting hole 226. The mounting disc 200 is arranged vertically and mounted into the mounting hole 226. In this embodiment, each of the two sides of the carrier 20 is arranged with one mounting disc 200. The electric field support 22 includes two mounting holes 226 corresponding to the mounting discs 200 on two sides of the carrier 20 respectively. Thus the mounting discs 200 on two sides of the carrier 20 are mounted to the mounting holes 226 on two sides of the electric field support 22. Thus the electric field support 22 is pivotally connected to the two sides of the carrier 20.

In addition, the side plate 26 includes a curved slot 260 on one side thereof corresponding to the mounting disc 200 while the electric field support 22 includes a curved edge 228. The curved edge 228 of the electric field support 22 is mounted in the curved slot 260 of the side plate 26 properly. In this embodiment, each side plate 26 includes a curved slot 260 corresponding to one side of each mounting disc 200 on two sides of the carrier 20. The electric field support 22 includes a curved edge 228 located on each of two sides thereof and corresponding to the curved slot 260 of the side plate 26. The curved edges 228 on two sides of the electric field support 22 are mounted in the curved slots 260 of the side plates 26 respectively. Thus the electric field support 22 is also pivotally connected to the side plates 26, beside the two sides of the carrier 20. These side plates 26 can also support the electric field support 22 without influence on rotation of the electric field support 22. Thus the angle of the electric field applied can be changed smoothly and easily. Therefore the angle of the electric field applied can be detected to optimize performance of the protein chips produced under the external electric field.

In addition, the curved slot 260 of the side plate 26 and the curved edges 228 of the electric field support 22 which mounted in the curved slot 260 can be designed into a regular polygon. In this embodiment, a circle is the optimal shape that allows the operation of the electric field device much smoother.

In summary, a method for performance optimization of protein chips produced under an external electric field of the present invention includes pretreatment steps of hydroxylation, formation of a self-assembled monolayer, and formation of a film of cross-linked molecules and the following steps. The external electric field with the same strength is applied in different directions to deflect the protein molecule and fix the protein molecule on the respective chip in different directions. Then a binding force between the protein molecule on the respective chip and the ligand for the protein molecule is measured and compared so as to find out the preferred direction of the external electric field applied that achieves performance optimization of the protein chips while using the protein molecules to produce the protein chips. Moreover, a device that provides an external electric field for production of protein chips of the present invention includes a carrier for loading protein chips and an electric field support pivotally connected to the carrier and rotatable around the carrier. The electric field support is disposed with electrodes so as to provide the external electric field passed through the protein chip in different directions.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for performance optimization of protein chips produced under an external electric field applied in different directions comprising the steps of:
taking and dropping a protein solution containing at least one protein molecule to a first chip;
applying an external electric field to the first chip for deflecting and fixing the protein molecule on the first chip while an angle between the external electric field and a line perpendicular to the first chip is a first angle;
taking and dropping the protein solution to a second chip;
applying an external electric field to the second chip for deflecting and fixing the protein molecule on the second chip while the angle between the external electric field and a line perpendicular to the second chip is a second angle;
measuring a first binding force between at least one ligand molecule for the protein molecule and the first chip, as well as a second binding force between the ligand molecule for the protein molecule and the second chip; and
comparing the first binding force with the second binding force to determine the angle of the external electric field applied that achieves performance optimization of the protein chips while using the protein molecule to produce the protein chips; the angle of the external electric field applied is selected from the group consisting of the first angel and the second angle.

2. The method as claimed in claim 1, wherein before the step of taking and dropping the protein solution to the first chip, the method further includes the steps of:
performing surface hydroxylation of a first chip;
forming a self-assembled monolayer on surface of the first chip; and
forming a film of cross-linked molecules over the self-assembled monolayer of the first chip.

3. The method as claimed in claim 1, wherein before the step of taking and dropping the protein solution to the second chip, the method further includes the steps of:
performing surface hydroxylation of a second chip;
forming a self-assembled monolayer on surface of the second chip; and
forming a film of cross-linked molecules over the self-assembled monolayer of the second chip;

4. The method as claimed in claim 1, wherein the ligand molecule is fixed on a probe of an atomic force microscope while the first binding force and the second binding force are measured by the atomic force microscope.

5. A method for performance optimization of protein chips produced under an external electric field applied in different directions comprising the steps of:
taking and dropping a protein solution containing at least one protein molecule to a plurality of chips respectively;
applying an external electric field in different directions to each of the chips while angles of the external electric field is selected as required; measuring a binding force between at least one ligand molecule for the protein molecule and the protein molecule on each of the chips; and
comparing the binding force with one another to get the angle of the external electric field applied that achieves performance optimization of the protein chips while using the protein molecule to produce the protein chips.

6. The method as claimed in claim 5, wherein before the step of taking and dropping the protein solution to the chips, the method further includes the steps of:
performing surface hydroxylation of a plurality of chips;
forming a self-assembled monolayer on surface of each of the chips; and
forming a film of cross-linked molecules over the self-assembled monolayer of each of the chips.

7. The method as claimed in claim 5, wherein the ligand molecule is fixed on a probe of an atomic force microscope while the binding force is measured by the atomic force microscope.

8. The method as claimed in claim 2, wherein oxygen plasma is used for performing surface hydroxylation.

9. The method as claimed in claim 3, wherein oxygen plasma is used for performing surface hydroxylation.

10. The method as claimed in claim 6, wherein oxygen plasma is used for performing surface hydroxylation.

11. The method as claimed in claim 2, wherein 3-Aminopropyltrimethoxysilane (3-APTMS) in alcohol solution is used for forming the self-assembled monolayer.

12. The method as claimed in claim 3, wherein 3-Aminopropyltrimethoxysilane (3-APTMS) in alcohol solution is used for forming the self-assembled monolayer.

13. The method as claimed in claim 6, wherein 3-Aminopropyltrimethoxysilane (3-APTMS) in alcohol solution is used for forming the self-assembled monolayer.

14. The method as claimed in claim 2, wherein glutar-aldehyde (GTA) aqueous solution is used for forming the film of cross-linked molecules.

15. The method as claimed in claim 3, wherein glutar-aldehyde (GTA) aqueous solution is used for forming the film of cross-linked molecules.

16. The method as claimed in claim 6, wherein glutar-aldehyde (GTA) aqueous solution is used for forming the film of cross-linked molecules.

17. The method as claimed in claim 2, wherein a covalent bonding is formed between the protein molecule and the film of cross-linked molecules.

18. The method as claimed in claim 3, wherein a covalent bonding is formed between the protein molecule and the film of cross-linked molecules.

19. The method as claimed in claim 6, wherein a covalent bonding is formed between the protein molecule and the film of cross-linked molecules.
